(19) United States
(12) Patent Application Publication
(10) Pub. No.: US 2008/0300079 A1
(43) Pub. Date: Dec. 4, 2008

(54) Silent Chain

(75) Inventors: Lucian Botez, Novi, MI (US); Klaus Hahn, Furth (DE); Bolko Schusell, Adelsdorf (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/571,769

(22) PCT Filed: Jun. 1, 2005
(86) PCT No.: PCT/EP05/05857

§ 371 Date: Aug. 10, 2007

Related U.S. Application Data
(60) Provisional application No. 60/585,624, filed on Jul. 6, 2004.

(51) Int. Cl. F16G 13/04

(52) U.S. Cl. 474/213

(57) ABSTRACT

A silent chain (1) is provided having plates that are interconnected via connecting members (5) and which have connecting openings, including two outer guide plates and, following these plates, at least two pivoting plates with a tooth-like profiling for a force-transmitting engagement on a toothed sprocket wheel, and at least one connecting plate between the pivioting plates are arranged on each of the connecting members. The guide plates (2) and the at least one connecting plate (4) are arranged in a press-fit fashion on the connecting member. The at least one connecting plate (4) also has a tooth-type profiling (7) to allow a force-transmitting engagement on the sprocket wheel.

### BACKGROUND

The invention relates to a silent chain comprising plates that are interconnected via connecting members and that are provided with connecting openings, including two outer guide plates and following these plates at least two pivoting plates with a tooth-like profile for a force-transmitting engagement with a toothed sprocket wheel and at least one connecting plate between these plates are arranged on each connecting member. The guide plates and the one or more connecting plates are arranged with a press-fit connection, and the two or more pivoting plates are arranged so that they can pivot on the connecting member.

Such silent chains, frequently also called inverted tooth-type chains, are known and predominantly used in vehicle construction, where they are used as timing chains. Such a chain is known, for example, from DE 689 18 842 T2 or the associated European Patent No. EP 0 384 076 B1. Reference is further made to U.S. Pat. No. 6,485,385 and U.S. Pat. No. 4,906,224. The individual plates are connected via a connecting peg or pin. They each have two connecting openings, through which connecting pins are placed. On the outside there are two guide plates, which are seated with the press-fit connection and thus cannot pivot in the area of the outer ends of the connecting pin. Following these components are at least two pivoting plates, which are held so that they can pivot on the connecting pins by means of an accordingly designed loose-fit connection. There is, in turn, at least one connecting plate, which is arranged like the outer guide plates also in the press-fit connection and thus cannot pivot on the connecting pin, between these components. The guide plates and the one or more connecting plates lie one behind the other—in the side view, while the pivoting plates are offset relative to this plate package. The construction of such inverted tooth-type chains is known and does not have to be described in more detail.

In the installed state, the silent chain interacts with at least two sprocket wheels, over which the chain is guided and to which corresponding drive units or other units are allocated. By means of the chain, the force is transmitted to or from a sprocket wheel. For this purpose the flanks of the pivoting plates facing a sprocket wheel have a tooth-like profile, that is, the flanks are constructed with corresponding engagement teeth, which intermesh with corresponding teeth of the respective sprocket wheel. Force is transferred exclusively via these tooth surfaces for such silent chains known, e.g., from DE 689 18 842 T2.

Due to the construction described above for the silent chains in question, according to which, as described, only the pivoting plates are toothed, the force-transmitting surface is relatively narrow in the area of the teeth. All of the force transmission and thus the entire load distribution are performed via these surfaces, which results in considerable stress and peak loads. This has a disadvantageous effect on the wear of the silent chain and the sprocket wheels. The length of the chain set over time is also affected disadvantageously.

### SUMMARY

The invention is based on the objective of providing a silent chain, which allows a better load distribution during the force transfer to the sprocket wheel.

To meet this objective, for a silent chain of the type according to the invention, the one or more connecting plates also have a tooth-like profile allowing a force-transmitting engagement with the sprocket wheel.

In the silent chain according to the invention, not only the pivoting plates, but also the one or more connecting plates have a tooth-type profile, that is, force is transmitted not only via the pivoting plates, but also via the connecting plates. In this way, the entire tooth surface, which interacts with the tooth surface of the opposite, sprocket wheel-side tooth, is significantly greater than in the silent chains noted above as defining the state of the art. In this case, the entire contact load is distributed over a larger surface, which is advantageous.

In the silent chain according to the invention, the condition that both the guide plates and also the one or more connecting plates are placed in a press-fit connection and thus cannot pivot on the connecting pin, and only the pivoting plates are mounted so that they can pivot, leads to the result that bending of the connecting pin is very strongly limited, like for silent chains, in which the middle connecting plate is also mounted so that it can pivot. In this way, deformation during the loading operation is advantageously counteracted. In connection with the additional advantage according to the invention of the optimized load distribution due to the large-area tooth or force transmission surface, overall a silent chain is produced, which is considerably improved with reference to the service life and which is subjected to significantly smaller plastic or elastic deformations during the operation than previously known silent chains.

The teeth of the connecting plates should be profiled according to the invention such that a common engagement with the sprocket wheel is realized together with the toothed profiling of the pivoting plates at least when both engage completely in the sprocket teeth. Due to the offset arrangement of the pivoting plates and the connecting plates relative to each other and due to the condition that the pivoting plates pivot relative to the connecting plate when running onto the sprocket wheel, the design of the teeth of the connecting plates should be selected so that under consideration of this behavior or the change in position of the pivoting plates relative to the connecting plate, a common contact of the plate-side teeth on the sprocket-wheel teeth is given as early as possible, at best during the running onto the sprocket wheel, in order to realize the maximum contact surface during the entire time of force transmission. The respective plates engage only with their outer teeth flanks on the sprocket wheel, but not with the tooth-gap profiles. Due to the offset arrangement of the pivoting plates relative to the connecting plate, when running onto the sprocket wheel, first the flanks of the pivoting plates and then the flanks of the connecting plates come into contact with the sprocket wheel, both are run onto and in contact with the sprocket wheel and the load is distributed to both. The optimum load distribution is thus produced at the moment—relative to a chain member—when both the pivoting plates and also the connecting plates are run onto.

In an advantageous improvement of the invention, the connecting openings of the guide plates and the one or more connecting plates have the same spacing and diameter, such that in connection with the connecting member, that is, the pin or peg, a press-fit connection is realized, while the connecting openings of the two or more pivoting plates have a smaller spacing with a larger diameter. The connecting openings of the guide plates and the one or more connecting plates are thus aligned with each other and a press-fit connection is realized. In contrast, the spacing of the connecting openings of the two or more pivoting plates is somewhat smaller. This has the result that these components are definitely held by a loose-fit connection so that they can pivot on the connecting pin, but the edges of the respective opening contact one side of the connecting pin due to the smaller spacing and the somewhat larger diameter. This means that the connecting pin has some play towards the inner wall of the connecting opening, but contact is realized at one point due to the smaller spacing. This means that in the case of an applied load, the connecting pin is also supported on the pivoting plates, which also counteracts a load-dependent deformation.

Frequently, the plates in question are produced through stamping. In this way, small truncated edges, which make the tooth diameter realized at the tooth end and thus the contact surfaces of the tooth flanks on the sprocket wheel and also the contact surfaces of the pivoting plates on the connecting pin somewhat smaller, are produced in the tooth area and in the area of the connecting openings dependent on production. The more the pivoting plates and connecting plates have been used, the greater this truncated-dependent surface is reduced, which is why an advantageous improvement of the invention increases the width of the pivoting plates and the connecting plates, for example, by at least 1.5 times, especially by at least 2 times the width of the guide plates, in comparison with known silent chains, in which their width corresponds essentially to the width of the guide plates. In the state of the art, e.g., from the already described DE 689 18 842 T2, multiple-plate chains are also known, in which two or more pivoting plate pairs and one or more connecting plate pairs are used. Each of the pivoting plates has the described truncated edges, which are added together due to the paired arrangement. Now, if wider plates are used according to the invention, there is the possibility of reducing the number of parts, that is, a chain with approximately the same properties can be realized due to the chain construction according to the invention, wherein significantly fewer parts, namely, in the simplest case only two pivoting plates and also one connecting plate and two guide plates are used. The width of the respective plate should be selected so that essentially similar contact surfaces are produced in the area of the flanks and openings, like for known multiple-part chains. Thus, an extremely stable chain of smaller mass and with greater compactness can be realized, which can be assembled in less time than the chains in question in the state of the art. Then, due to the inclusion of the connecting plate for force transmission, the use of several pivoting plates is no longer required like before. Naturally this does not exclude using several pivoting plate pairs and connecting plate pairs, when a very wide chain is guided. The advantages that can be achieved according to the invention, however, are still maintained in comparison with a correspondingly wide chain of the state of the art.

To be able to solve the problem of the truncated edges as well as possible, it is preferable when the two or more pivoting plates and the one or more connecting plates are produced through fine stamping, wherein, according to one construction of the invention, these plates also feature a different width than each pivoting plate, so that the possible truncated edges can be reduced to a minimum. However, other production techniques can also be used, as long as a sufficiently exact production is possible.

### BRIEF DESCRIPTION OF THE DRAWINGS

FIG. 1 shows a side view of a silent chain according to the invention,

FIG. 2 shows a top view in section of the silent chain from FIG. 1,

FIG. 3 shows an enlarged section view in the region of the plate connection,

FIG. 4 shows an end view of the area of the toothed section of the plate,

FIG. 5 shows a detailed side view of the silent chain according to the invention for illustrating the connecting opening spacing, and

FIG. 6 shows a detailed view of a silent chain according to the invention run onto a sprocket wheel.

### DETAILED DESCRIPTION OF THE PREFERRED EMBODIMENTS

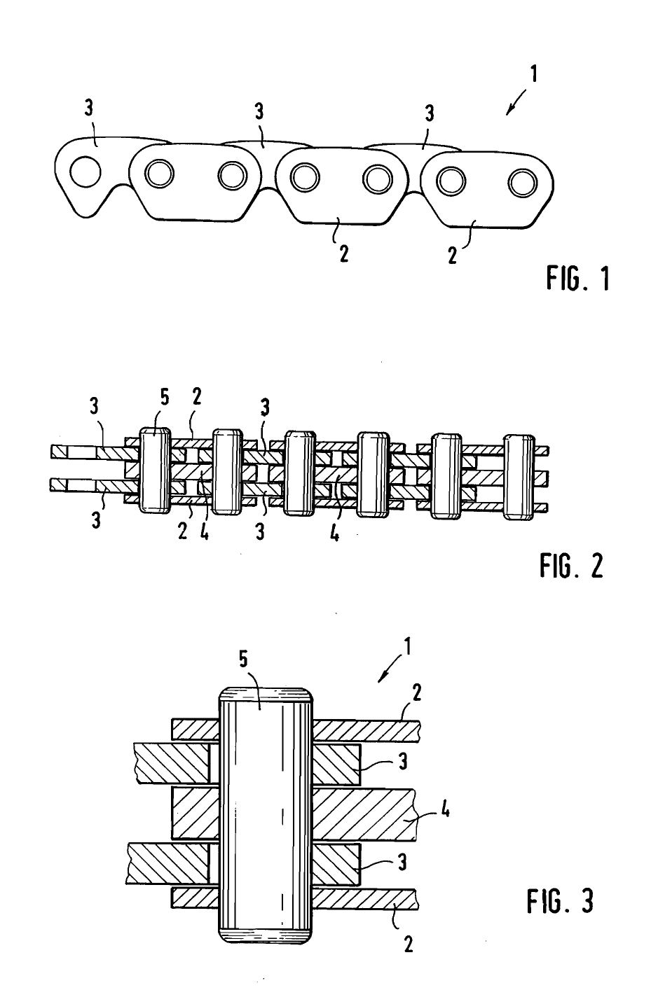

FIG. 1 shows an inverted tooth-type chain 1 according to the invention comprised of lateral guide plates 2 lying on the outside, which are followed by two pivoting plates 3 in the shown embodiment, between which there is, in turn, a connecting plate 4. As follows from the section view according to FIG. 2, the guide plates 2 and the connecting plate 4 lie essentially congruent with each other, while the pivoting plates are positioned offset to these components. The plates themselves have corresponding connecting openings, through which is placed a connecting member 5 in the form of a connecting pin or connecting peg, which is relatively thick for improving the wear resistance and for preventing bending. While the spacing and the diameter of the respective connecting openings of the guide plates 2 and the connecting plate 4 are selected so that both sit in a press-fit connection on the connecting member 5, consequently they cannot pivot, the diameter of the connecting openings of the pivoting plates is selected somewhat larger, so that they are held in a loose-fit connection on the connecting member 5. The spacing is selected somewhat smaller, so that the inner wall of the opening contacts the connecting member 5 at a point, which will be discussed below.

In an enlarged view, FIG. 3 shows a cut-out from the chain 1 according to the invention with the already described elements. It is clear that the two pivoting plates 3 and the connecting plate 4 are significantly wider than the guide plates 2, preferably twice as wide, in order to realize the greatest possible tooth contact surface, which will be described below. Preferably, the pivoting plates and the connecting plate have different thicknesses and outer contours, so that the parts can be arranged easily during assembly.

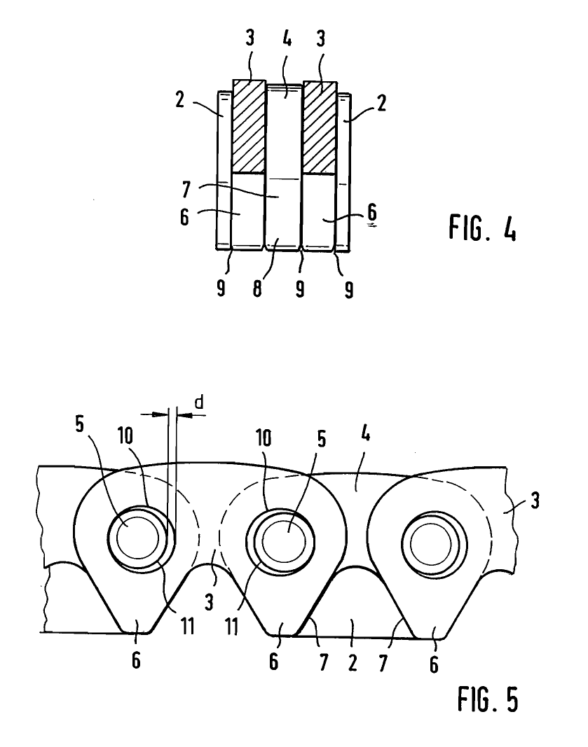

This tooth profiling, which allows a large tooth contact surface, is shown in detail in FIGS. 4 to 6. Starting with FIG. 5—while leaving out the guide plates at the front—the pivoting plate 3 is shown, on which two teeth 6 are provided, as is typical for such silent chains. Further shown is the connecting plate 4, on which there are also two teeth 7, which are covered by the teeth 6 of the pivoting plates.

This tooth design leads to the result that tooth contact surfaces 8 corresponding to the respective tooth outer flanks are realized by means of the teeth 6, 7—see the front view in FIG. 4. These tooth contact surfaces come into contact with the sprocket wheel due to the offset arrangement of the pivoting plates 3 relative to the connecting plate 4 when running onto the sprocket wheel one after the other, which is why only the tooth contact surface 8 of the tooth 7 of the connecting plate 4 is shown in the section view of FIG. 4, while the inner flanks of the teeth not coming into contact with the sprocket wheel are seen of the pivoting plates 3 illustrated in a section view. If both plates run onto the wheel, the tooth flanks of both the teeth 6 and also the teeth 7, consequently both the pivoting plates 3 and also the connecting plate 4, are in a meshing and force-transmitting engagement with a tooth of the sprocket wheel. This construction produces a significantly better load distribution over a larger surface.

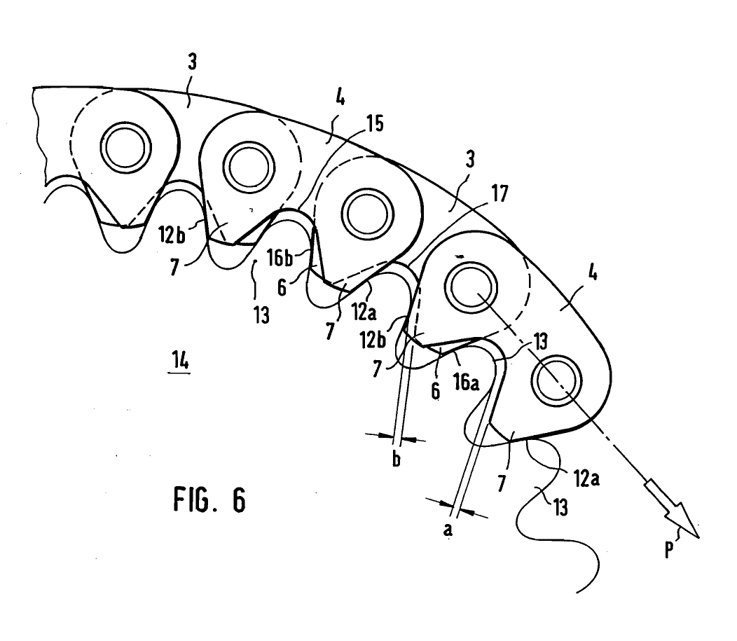

The contact points of the respective tooth outer flanks of the teeth 6 and 7 of the pivoting plates 3 and the connecting plate 4 follow from FIG. 6. The chain moves in the direction of the arrow P. The connecting plate 4 shown at the front in the direction of movement contacts the respective tooth flank of the adjacent tooth 13 of the sprocket wheel 14 with the front tooth outer flank 12a of its tooth 7, i.e., the tooth outer flank 12a forms the tooth contact surface 8, as described with reference to FIG. 4. The tooth flank 12b located at the other tooth is not in contact with the sprocket wheel 14; it has minimal play. The tooth intermediate space 15 between the two teeth 7 is also not in contact with the sprocket wheel, also not the inner flanks of the teeth 7. These are clearly spaced apart, as shown by the distance measure a. The force-transmitting contact is given just by means of the tooth outer flank 12a. In the reverse direction of movement, the tooth outer flank 12b then contacts the sprocket wheel; the tooth outer flank 12a has minimal play.

Accordingly, the following pivoting plate 3 is in contact with the adjacent tooth flank of the sprocket wheel teeth 13 only via the front tooth outer flank 16a of the tooth 6 forming the tooth contact surface in this direction of movement. The tooth intermediate space 17 between the teeth 6 and also the tooth inner surfaces are also not in contact with the sprocket wheel, as shown by the distance measure b. Here, the tooth outer flank 16b also has minimal play and does not engage the sprocket wheel 14. In the reverse direction of movement, however, the tooth flank 16b is in contact with the sprocket wheel and the tooth flank 16a is free.

The shape or contours of the teeth 6, 7 should preferably be selected under consideration of the relative movement of the pivoting plates 3 with reference to the connecting plate 4 while running onto and around the sprocket wheel. It should be guaranteed that at least when the relative movement of the plates relative to each other is completed after running onto the sprocket wheel, the maximum contact surface is realized. FIGS. 4 to 6 are only schematic diagrams, which do not precisely reproduce the real tooth shape of the individual teeth in detail.

Incidentally, from FIG. 4 it follows that the truncated edges 9 on the teeth 6, 7 reduce the total surface only insignificantly depending on production due to the relatively wide construction of the plates, consequently due to the teeth according to the invention both of the pivoting plates 3 and also the connecting plate 4 makes available an large optimized force-transmission surface.

It further follows from FIG. 5 that the through holes 10 of the pivoting plates 3 have a smaller spacing that the through holes 11 of the connecting plate 4 or the guide plates 2, which are shaped in diameter so that a press-fit connection with the connecting pin is realized and are equal in spacing and are aligned with each other in the installed condition. The diameter of the through holes 10 is larger, as FIG. 4 clearly shows, so that a loose-fit connection to the connecting member 5 is produced. The spacing is reduced overall by the measure d. This leads to the fact that after assembly, the connecting member 5 contacts opposite sides of the respective connecting openings 10 of the pivoting plates 3; thus a one-sided loose-fit connection or a one-sided contact is realized. This leads to the fact that the connecting pin is supported not only by means of the press-fit connection of the guide plates and the connecting plate, but instead based on the smaller spacing also by means of the pivoting plates 3, which counteracts an operating-dependent elongation.

At this point it should be mentioned that instead of the embodiment shown in FIG. 2 with two pivoting plates and one connecting plate, corresponding plate pairs could also be used for wide chains. Alternatively, there is also the possibility, for example, to provide three pivoting plates and two connecting plates or corresponding pairs alternately, wherein naturally in this case the connecting plates are also constructed with teeth. The production is performed overall preferably through a fine-stamping process, but is not limited to this process, as long as it is guaranteed that, on one hand, the truncated edges are as small as possible and, on the other hand, the contacting surfaces are worked cleanly as much as possible and friction losses are prevented. The construction according to the invention can be selected for any spacing.

### REFERENCE SYMBOLS

1 Silent chain
2 Guide plates
3 Pivoting plates
4 Connecting plate
5 Connecting member
6 Teeth
7 Teeth
8 Tooth contact surfaces
9 Truncated edges
10 Through holes
11 Through holes

1. Silent chain comprising plates, which are interconnected via connecting members and which have connecting openings, including two outer guide plates and, following these plates, at least two pivoting plates with a tooth profiling for a force-transmitting engagement on a toothed sprocket wheel, and at least one connecting plate between the pivoting plates arranged on each of the connecting members, wherein the guide plates and the at least one connecting plate are arranged with a press-fit connection on the connecting member and the at least two pivoting plates can pivot on the connecting member, the at least one connecting plate also has a tooth profiling allowing a force-transmitting engagement on the sprocket wheel.

2. Silent chain according to claim 1, wherein the tooth profiling of the at least one connecting plate is such that a common engagement on the sprocket wheel is realized together with the tooth profiling of the pivoting plates at least when both engage completely in the sprocket wheel teeth.

3. Silent chain according to claim 1, wherein connecting openings of the guide plates and the at least one connecting plate have the same spacing and diameter, such that a press-fit connection on the connecting member is realized, while connecting openings of the at least two pivoting plates have a smaller spacing with a larger diameter.

4. Silent chain according to claim 1, wherein only two of the pivoting plates and only one of the connecting plate are provided.

5. Silent chain according to claim 1, wherein at least three of the pivoting plates and at least two of the connecting plates are provided, which are arranged in an alternating pattern.

6. Silent chain according to claim 1, wherein pairs of the pivoting plates and the connecting plates are provided.

7. Silent chain according to claim 1, wherein the pivoting plates and the at least one connecting plate are wider than the guide plates.

8. Silent chain according to claim 7, wherein a width of the pivoting plates and the at least one connecting plate equals at least 1.5 times a width of the guide plates.

9. Silent chain according to claim 7, wherein at least one connecting plate has a different width than each of the pivoting plates.

10. Silent chain according to claim 1, wherein the at least two pivoting plates and the at least one connecting plate are produced with fine stamping.

11. Silent chain according to claim 1, wherein outer contours of the at least one connecting plate are different than outer contours of the pivoting plates.
